(19) United States
(12) Patent Application Publication
(10) Pub. No.: US 2024/0004842 A1
(43) Pub. Date: Jan. 4, 2024

(54) REBALANCE METHOD FOR BLOCKCHAIN-BASED DECENTRALIZED FILE SYSTEM

(71) Applicant: HUNAN TIANHE GUOYUN TECHNOLOGY CO., LTD., Changsha (CN)

(72) Inventors: Lin TAN, Changsha (CN); Xiangxiang LI, Changsha (CN); Zheng YANG, Changsha (CN); Haibo YIN, Changsha (CN)

(21) Appl. No.: 18/469,537

(22) Filed: Sep. 18, 2023

Related U.S. Application Data
(63) Continuation of application No. PCT/CN2021/141178, filed on Dec. 24, 2021.

(30) Foreign Application Priority Data
Apr. 21, 2021 (CN) 2021104274636

(51) Int. Cl. G06F 16/182; H04L 67/1097; H04L 67/1014; H04L 67/104; G06F 16/13

(52) U.S. Cl. CPC G06F 16/184; H04L 67/1097; H04L 67/1014; H04L 67/1048; G06F 16/134

(57) ABSTRACT

A rebalance method for blockchain-based decentralized file system is provided, and the method includes an encoded data rebalance method of a deleted node, and the encoded data rebalance method of the deleted node includes: broadcasting a codeword of the deleted node to all remaining nodes when one node of a node set is deleted; and decoding based on a current storage content and the codeword transmitted from the deleted node by each remaining node using a decoding function to obtain a data packet of each remaining node, and storing the data packet into each remaining node, to thereby generating a distributed target file storage system. The method can correct data skew and reduce replication factors while reducing a communication load of transmission codes during a rebalance phase, thereby ensuring optimal performance of the decentralized file system.

### TECHNICAL FIELD

The disclosure relates to the field of blockchain applications, and more particularly to a rebalance method for blockchain-based decentralized file system.

### BACKGROUND

In the blockchain applications, large-scale data storage relies critically on a reliable distributed file system to effectively store and process data. Uneven data distribution across storage nodes is one of main factors leading to poor data storage performance. In order to ensure reliability of using the blockchain-based decentralized file system, and ensure a reliable replicator in a complex node environment, data needs to be rebalanced so that all nodes store approximately the same amount of data, thereby reducing data skew. Furthermore, in order to improve performance of a file storage system, and efficiently store and process the data, a rebalance method must ensure that these replicators are not reduced during a rebalance period when the file storage system has data replicated using certain replicators.

### SUMMARY

A purpose of the disclosure is to provide a rebalance method of blockchain-based decentralized file system to solve the above problems.

The rebalance method of blockchain-based decentralized file system provided in the disclosure includes an encoded data rebalance method of a deleted node, and the encoded data rebalance method of the deleted node includes broadcasting a codeword of the deleted node to all remaining nodes when one node of a node set is deleted; and decoding based on a current storage content and the codeword transmitted from the deleted node by each remaining node using a decoding function to obtain a data packet of each remaining node, and storing the data packet into each remaining node, to thereby generate a distributed target file storage system.

In an exemplary embodiment, the rebalance method of blockchain-based decentralized file system further includes: receiving data from a user terminal by a server and storing the data into a target node of the distributed target file storage system.

In an embodiment, the encoded data rebalance method of the deleted node includes:
setting a node

$${m}^{′} ∈ ( \begin{matrix}[ K ] ∖ k \\ K - r - 1\end{matrix} ) ,$$

making {p₁ , . . . , pᵣ}=[K]\(m′∪k), where {p₁ , . . . , pᵣ} represents a set composed of nodes {p₁ , . . . , pᵣ}, and [K]\(m′∪k) represents a set of remaining nodes in a node set [K] after deleting the node m′ and a node k;
transmitting a data packet |W_{[p}_{ₗ}_{,m′]}^{p}^{ᵢ}|:pₗ≠pᵢ by the node k to a node pᵢ;
for the node pᵢ∈[K]\(m′∪k), filling the data packet |W_{[p}_{ₗ}_{,m′]}^{p}^{ᵢ}|:pₗ≠pᵢ by using a virtual null position |W_{[p}_{ₗ}_{,m′]}^{p}^{ᵢ}|={|W_{[p}_{ₗ}_{,m′]}^{p}^{ᵢ}|:pₗ≠pᵢ };
transmitting

$${X}_{{p}_{i} , {m}^{′}} = \begin{matrix}⊕ \\ {p}_{l} \neq {p}_{i}\end{matrix} {W}_{[ {p}_{l} , {m}^{′} ]}^{{p}_{i}}$$

by the node pᵢ, where ⊕ represents an exclusive or (XOR) operation; and
decoding a requirement W_{[p}_{ⱼ}_{,m′]}^{p}^{ᵢ}of a node pⱼ based on the Xₚ_{ᵢ}_{,m′} and a storage content of the node pⱼ after completing the transmitting, where a process for the decoding is expressed as follows:

$${X}_{{p}_{i} , {m}^{′}} ⊕ ( \begin{matrix}⊕ \\ {p}_{l} \neq {p}_{j} , {p}_{i}\end{matrix} {W}_{[ {p}_{l} , {m}^{′} ]}^{{p}_{i}} ) = ( \begin{matrix}⊕ \\ {p}_{l} \neq {p}_{i}\end{matrix} {W}_{[ {p}_{l} , {m}^{′} ]}^{{p}_{i}} ) ⊕ ( \begin{matrix}⊕ \\ {p}_{l} \neq {p}_{j} , {p}_{i}\end{matrix} {W}_{[ {p}_{l} , {m}^{′} ]}^{{p}_{i}} ) = {W}_{[ {p}_{l} , {m}^{′} ]}^{{p}_{i}} ;$$

$$where \begin{matrix}⊕ \\ {p}_{l} \neq {p}_{j} , {p}_{i}\end{matrix} {W}_{[ {p}_{l} , {m}^{′} ]}^{{p}_{i}}$$

represents an XOR transmission of a data packet W_{[p}_{ₗ}_{,m′]}^{p}^{ᵢ} of another node pₗ after deleting the node pⱼ and the node pᵢ.

In an embodiment, the rebalance method for blockchain-based decentralized file system further includes an encoded data rebalance method of an added node, and the encoded data rebalance method of the added node includes broadcasting, based on a preset decoding function, the codeword by each initial node (i.e., existing node) to a target node (i.e., newly added node) when the target node is added into the node set; and decoding the codeword by the target node using the preset decoding function, and deleting a corresponding data packet from each initial node, to thereby generate a distributed target file storage system.

In an embodiment, the encoded data rebalance method of the added node includes:
adopting [symbol] _{[K]} to represent an index of a bit set storing at K initial nodes, and

$${𝒜}_{[ K ]} = ( \begin{matrix}[ K ] \\ K - r\end{matrix} ) ;$$

setting a node m∈ [symbol] _{[K]}, Uₘ={W_{[k,m]}:∀k∈[K]\m}; for a bit of a data packet W_{[k,m]}, using a node indexed by [K]\m to represent a node set initially storing the node, [K]\m to represent remaining nodes in the node set [K] after deleting the node m; setting an initial node k∈[K], where the node m is different from the node k, and the data packet W_{[k,m]} is labeled and existed in storage of the node m; and
transmitting, by the initial node k∈[K], a data packet

$${W}_{[ k , m ]} : ∀ m ∈ ( \begin{matrix}[ K ] ∖ k \\ K - r\end{matrix} )$$

to a target node k+1, and deleting the data packet

$${W}_{[ k , m ]} : ∀ m ∈ ( \begin{matrix}[ K ] ∖ k \\ K - r\end{matrix} )$$

from the initial node, to thereby make the target node K+1 store the data packet transmitted by each initial node.

Compared to the related art, beneficial effects of the disclosure are as follows.
1. Problems of data skew and reduction in replicator caused by deleting nodes and adding nodes in the decentralized file storage system may be reduced, and optimal performance of the decentralized file storage system is achieved.
2. A communication load of transmission codes in a rebalance stage is minimized by selecting data packets transmitted from different nodes and performing the XOR operation on the selected data packets, and efficiency for rebalancing the decentralized file storage system is ensured.

### BRIEF DESCRIPTION OF DRAWINGS

In order to provide a clearer explanation of technical solutions in the disclosure, drawings required in embodiments descriptions will be introduced below, the following described drawings are merely some embodiments of the disclosure, other drawings can be obtained according to these drawings for those skilled in the art without creative labor.

FIG. 1 illustrates a flowchart of an encoded data rebalance method of a deleted node according to an embodiment of the disclosure.

FIG. 2 illustrates a flowchart of an encoded data rebalance method of an added node according to an embodiment of the disclosure.

FIG. 3 illustrates a schematic diagram of a data packet transmitted during a rebalance process of the deleted node according to an embodiment of the disclosure.

FIG. 4 illustrates a schematic diagram of a data packet transmitted during a rebalance process of the added node according to an embodiment of the disclosure.

### DETAILED DESCRIPTION OF EMBODIMENTS

Technical solutions in embodiments of the disclosure will be clearly and completely described below. Obviously, the described embodiments are merely some of the embodiments of the disclosure, not all of them. Based on the embodiments of the disclosure, all other embodiments obtained by those skilled in the art without creative labor fall within a scope of protection of the disclosure.

A blockchain technology is a peer-to-peer (P2P) network based on decentralization, the blockchain technology combines, by using an open-source software (OSS), a principle of cryptography, temporal data, and a consensus mechanism to ensure coherence and continuation of nodes in a distributed database, so that information can be verified and traced immediately, but it is difficult to tamper with and cannot be masked, thereby creating a privacy, efficient, and secure shared value system.

In an application of the blockchain technology, uneven data distribution across storage nodes is one of main factors leading to poor performance of data storage and analysis platform. The uneven distribution of data is called data skew. During data rebalance, data moves between storage nodes so that all nodes store approximately the same amount of data, thereby reducing data skew. Moreover, when a storage system has data replicated using certain replicators, a rebalance method must ensure that these replicators are not reduced during a rebalance period. An efficient data rebalance algorithm minimizes communication involved in the rebalance process.

The disclosure mainly addresses a design of a rebalance method for a decentralized file storage system. The decentralized distributed file storage system is r-balanced, that is a replicator of each data segment in the decentralized file storage system is r. A definition of the replicator includes the following: a distributed file storage system D and a node subset S⊂[K] ([K] represents a node set) are considered, a file W is composed of a set of F fragment, the number of nodes storing wᵢ(i∈[F]) is called the replicator of a bit wᵢ, and wᵢ represents i-th (i∈[F]) fragment of the file W. An expected number of bits stored in each node is the same. For the r-balanced file storage system, a definition of the decentralized r-balance file storage system is as follows: D(r,[K])={Dₙ⊆W:n∈[K]} represents a decentralized r-balanced file storage system of k nodes, and the decentralized r-balanced file storage system needs to satisfy the following two conditions.

A first condition is a replicator condition, the replicator of each bit is r, and rᵢ=r,∀i∈[F], where [F] is a fragment set of the file W.

A second condition is a rebalance state condition, the expected number of bits stored in each node is the same. Since the number of bits of the node is rF ,which means that for n∈[K], E(|Dₙ|)=λF is satisfied,

$$λ = \frac{Δ r}{K}$$

and is a storage point.

The disclosure provides a rebalance method of a file system for adding and deleting single node. The rebalance method can ensure that the replicator and balance attribute of the distributed file storage system are maintained at the same time.

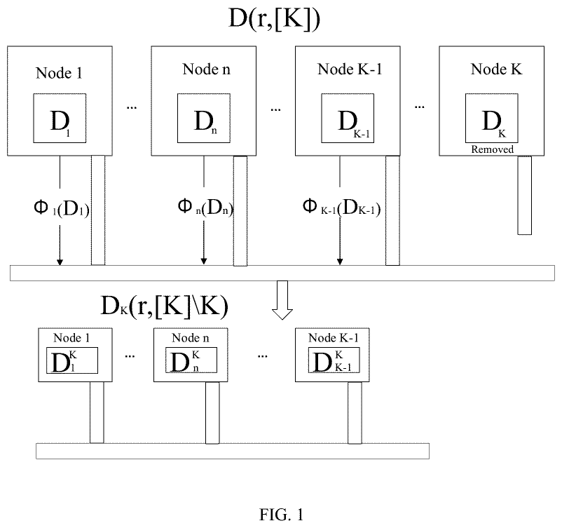

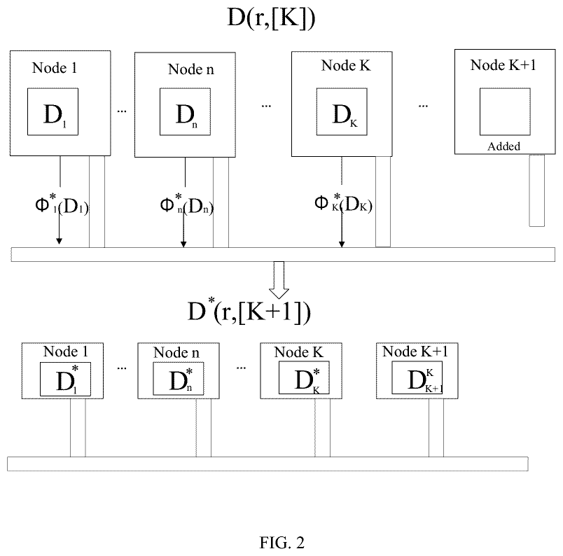

Overall processes of the embodiments of the disclosure are shown in FIG. 1 and FIG. 2, and the overall processes include a rebalance process of the deleted node, and a rebalance process of the added node. The embodiments shown in FIG. 1 and FIG. 2 will be described in detail by the following content.

Embodiment 1 shows the rebalance process of the deleted node.

In order to ensure high reliability of the file storage system, and maintain the replicator r of the file storage system, a decentralized r-balanced distributed file storage system D(r,[K]) is considered, and [K] represents a set of nodes. A node k∈[K] is deleted, Dₖ(r,[K]\k)={Dₙ^{k}:n∈[K]\k} is used to represent the decentralized r-balanced distributed file storage system obtained by rebalance a new system composed by a node set [K]\k ([K]\k represents a set of remaining nodes in the node set [K] after deleting the node k). Specifically, both K and k represent nodes.

R (k, D, Dₖ) is used to represent a rebalance method of the deleted node k from the database D(r, [K]), and Dₖ represents a target database after balancing. The Dₖ includes a series encoding functions {ϕₙ:∀n∈[K]\k} and decoding functions {ψₙ:∀n∈[K]\k}. Specifically, [K]\k represents the set of remaining nodes in the node set [K] after deleting the node k. For the node n∈[K]\k, a codeword ϕₙ(Dₙ) with a length of lₙ is broadcasted to all remaining nodes. Each remaining node n≠k can decode, by using the decoding function ψn , a data transmission requirement Dₙ^{k} of the node k through a current storage content Dₙ and codewords received from other remaining nodes.

[symbol] ₖ is used to represent a bit set storing at the deleted node k, and

$${𝒜}_{k} = ( \begin{matrix}[ K ] ∖ k \\ K - r\end{matrix} ) .$$

For m∈ [symbol] ₖ, m is a node of bits of the bit set [symbol] ₖ. Wₘ represents a bit set that cannot be obtained at the node m and can be obtained at r-1 remaining nodes [K]\(m∪k) . For m∪ [symbol] ₖ, {Wₚ_{ⱼ}_{,m′}_{ⱼ}^{α}:∀pⱼ∈[m],m′ⱼ=[m]\pⱼ,∀α∈[K]\(m∪k)} is used to represent a set of (K−1)(r−1) boxes, and pⱼ represents a node of a node set [m]; m′ⱼ=[m]\pⱼ represents remaining nodes after deleting the node pⱼ from the node set [m]; α∈[K]\(m∪k) represents that α belongs to a set of remaining nodes of the node set [K] after deleting the node m and the node k. Each bit in the bit set Wₘ is associated with a randomly and uniformly selected box. The merging process is executed at a certain node in the node set [K]\(m∪k) containing the bit set Wₘ, and [K]\(m∪k) represents the set of remaining nodes of the node set [K] after deleting the node m and the node k. The bit in the bit set W m is transmitted to all other nodes in the node set [K]\(m∪k). In this way, all these nodes have a same bit in their respective boxes, which is collectively referred to as a bit set that selects a same box as the data packet, and the bit is indexed by a tag of the box they jointly select.

Considered arbitrary

$${m}^{′} ∈ ( \begin{matrix}[ K ] ∖ k \\ K - r - 1\end{matrix} ) ,$$

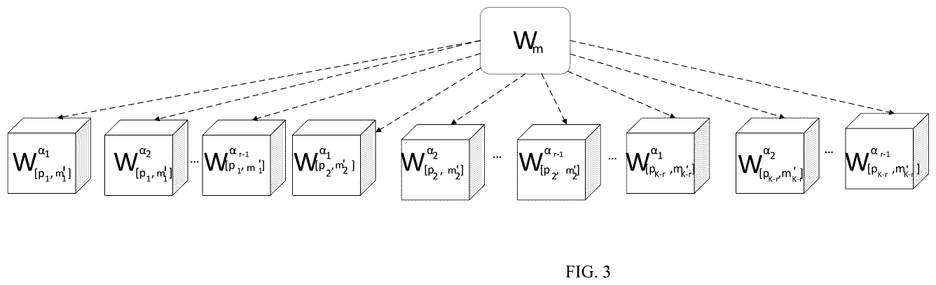

for any such m′, a set P_{m′}={p₁ , . . . , pᵣ}=[K](m′∪k) of the remaining nodes is considered. For any Pᵢ∈P _{m′}, a set of r−1 data packets of {W_{[p}_{ⱼ}_{,m′]}^{p}^{ᵢ}:∀pⱼ≠pᵢ} is considered. A data packet W_{[p}_{ⱼ}_{,m′]}^{p}^{ᵢ} can be obtained at the deleted node, and can be also obtained at all remaining nodes pₗ:l≠j, however, the data packet W_{[p}_{ⱼ}_{,m′]}^{p}^{ᵢ} cannot be obtained at the node pⱼ. Bits in the data packet W_{[p}_{ⱼ}_{,m′]}^{p}^{ᵢ}are accurately stored in the node pⱼ. Considering that they have a same size, this structure allows these data packets to be performed an exclusive or (XOR) transmission by nodes. The node pⱼ can decode W_{[p}_{ⱼ}_{,m′]}^{p}^{ᵢ}. Please refer to FIG. 3.

An algorithm of the encoded data rebalance method for the deleted node includes the following steps 0-2.

In step 0, a node

$${m}^{′} ∈ ( \begin{matrix}[ K ] ∖ k \\ K - r - 1\end{matrix} )$$

is set, making {p₁, . . . , pᵣ}=[K]\(m′∪k) , where {p₁ , . . . , pᵣ} represents a set composed by nodes p₁ , . . . , pᵣ, [K]\(m′∪k) represents the set of remaining nodes in the node set [K] after deleting the node m′ and the node k.

In step 1, for a node pᵢ∈[K]\(m′∪k), a data packet |W_{[p}_{ₗ}_{,m′]}^{p}^{ᵢ}|:pₗ≠pᵢ is filled by using a virtual null position |W_{[p}_{ₗ}_{,m′]}^{p}^{ᵢ}|=max{|W_{[p}_{ₗ}_{,m′]}^{p}^{ᵢ}|:pₗ≠pᵢ}.

In step 2,

$${X}_{{p}_{i} , {m}^{′}} = \begin{matrix}⊕ \\ {p}_{l} \neq {p}_{i}\end{matrix} {W}_{[ {p}_{l} , {m}^{′} ]}^{{p}_{i}}$$

is transmitted by the node pᵢ, where ⊕ represents an XOR operation, and a process for the transmitting is finished.

After completing the process for the transmitting, a requirement W_{[p}_{ⱼ}_{,m′]}^{p}^{ᵢ} (i.e., data packet) of the node pⱼ is decoded based on the Xₚ_{ᵢ}_{,m′} and a storage content of the node pⱼ, and a process for the decoding is expressed as follows:

$${X}_{{p}_{i} , {m}^{′}} ⊕ ( \begin{matrix}⊕ \\ {p}_{l} \neq {p}_{j} , {p}_{i}\end{matrix} {W}_{[ {p}_{l} , {m}^{′} ]}^{{p}_{i}} ) = ( \begin{matrix}⊕ \\ {p}_{l} \neq {p}_{i}\end{matrix} {W}_{[ {p}_{l} , {m}^{′} ]}^{{p}_{i}} ) ⊕ ( \begin{matrix}⊕ \\ {p}_{l} \neq {p}_{j} , {p}_{i}\end{matrix} {W}_{[ {p}_{l} , {m}^{′} ]}^{{p}_{i}} ) = {W}_{[ {p}_{l} , {m}^{′} ]}^{{p}_{i}} ;$$

$$where \begin{matrix}⊕ \\ {p}_{l} \neq {p}_{j} , {p}_{i}\end{matrix} {W}_{[ {p}_{l} , {m}^{′} ]}^{{p}_{i}}$$

represents the XOR transmission of a data packets W_{[p}_{ₗ}_{,m′]}^{p}^{ᵢ} of another node pₗ after deleting the node pⱼ and the node pᵢ. The data requirement packet W_{[p}_{ⱼ}_{,m′]}^{p}^{ᵢ} is decoded in this way, and is accurately stored in the node pⱼ. After completing the algorithm, the distributed file storage system Dₖ(r, [K]\k) is obtained.

Embodiment 2 shows the rebalance process of the added node.

A target node with an index of K+1 is added into a system of the node set [K], the added target node is assumed as blank, thus the data skew of the system is caused. After executing a rebalance operation of the added node, the decentralized r-balanced distributed file storage system D*(r,[K+1])={D*ₙ⊂W:n∈[K+1]} is obtained.

In generally, the rebalance method of the added node is composed of a series encoding functions {ϕn:∀n∈[K]} and decoding functions {ψn:∀n∈[K+1]}. A codeword ϕ*ₙ(Dₙ) with a length of lₙ is broadcasted by the initial node n∈[K]. For a transmitted codeword, the target node uses a decoding function ψ*_{K+1}(ϕ*ₙ(Dₙ):n∈[K])=D*_{K+1} to decode. A requirement D*ₙ of the initial node n∈[K] is decoded by the initial node n∈[K] using its decoding function such as ψ*ₙ(Dₙ, (ϕ*ⱼ(Dⱼ):j∈[K]\n))=D*ₙ.

In order to restore a balance state destroyed of the file storage system D(r, [K]) after adding the target node K+1, the encoded data rebalance method of the added node is implemented. In the method, some bits from the storage content of each node in the K numbers of initial nodes are deleted , and the bits are transmitted to the target node, thereby establishing a new decentralized r-balanced distributed file storage system D*(r, [K+1]). [symbol] _{[K]} is used to represent an index of a bit set storing at the K numbers of initial nodes, and

$${[ K ]}_{} = ( \begin{matrix}[ K ] \\ K - r\end{matrix} ) .$$

A node m∈ [symbol] _{[K]} is set, a set Uₘ is used to represent r boxes, and Uₘ={W _{[k,m]}:∀k∈[K]\m}.

For a bit of a data packet W_{[k,m]}, a node indexed by [K]\m is used to represent a node set initially storing the node, [K]\m is used to represent remaining nodes in the node set [K] after deleting the node m. Moreover, an initial node k∈[K] is set, for the node m:k∉m, that is, the node m is different from the node k, and the data packet W_{[k,m]} is labeled and existed in the

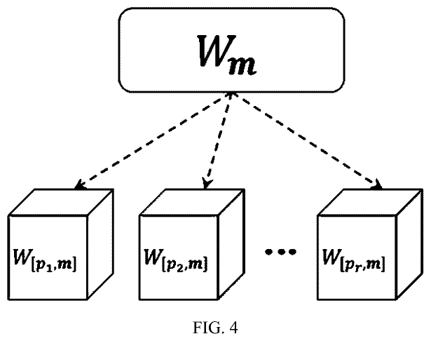

storage of the node m . Please referring to FIG. 4. The data packet

$$∀ k ∈ ( \begin{matrix}[ K ] ∖ k \\ K ‐ τ\end{matrix} )$$

is transmitted by the initial node k∈[K] to the target node K+1, and the data packet is deleted from the initial node k∈[K]. The data packet transmitted from the initial node is stored in the target node K+1. The obtained file storage system is defined as D*(r, [K+1]).

An algorithm of the encoded data rebalance method of the added node includes the following steps 0-1.

In step 0, for the node k∈[K] and the node

$$m ∈ ( \begin{matrix}[ K ] ∖ k \\ K - r\end{matrix} ) , {X}_{k , m}^{*} = {W}_{[ k , m ]}$$

is transmitted by the node k to the node K+1.

In step 1, the node k deletes the data packet W_{[k,m]} from itself, and the algorithm of the encoded data rebalance method of the added node is finished.

What is claimed is:

1. A rebalance method for blockchain-based decentralized file system, comprising an encoded data rebalance method of a deleted node, wherein the encoded data rebalance method of the deleted node comprises:
broadcasting a codeword of the deleted node to all remaining nodes when one node of a node set is deleted; and
decoding based on a current storage content and the codeword transmitted from the deleted node by each remaining node using a decoding function to obtain a data packet of each remaining node, and storing the data packet into each remaining node, to thereby generate a distributed target file storage system.

2. The rebalance method for blockchain-based decentralized file system as claimed in claim 1, wherein the encoded data rebalance method of the deleted node comprises:
setting a node
$${m}^{′} ∈ ( \begin{matrix}[ K ] ∖ k \\ K - r - 1\end{matrix} ) , wherein ( \begin{matrix}[ K ] ∖ k \\ K - r - 1\end{matrix} )$$
represents a set of subsets of K−r−1 nodes selected from a node set [K]\k, [K]\k represents a set of remaining nodes in a node set [K] after deleting a node k, r represents a replicator, both K and k represent nodes; and making {p₁ , . . . , pᵣ}=[K]\(m′∪k), wherein {p₁ , . . . , Pᵣ} represents a set comprised of nodes p₁ , . . . , pᵣ, and [K]\(m′∈k) represents a set of remaining nodes in the node set [K] after deleting the node m′ and the node k;
for a node pᵢ∈[K]\(m′∪k), filling a data packet |W_{[p}_{ₗ}_{,m′]}^{p}^{ᵢ}|:pₗ≠pᵢ by using a virtual null position |W_{[p}_{ₗ}_{,m′]}^{p}^{ᵢ}|=max {|W_{[p}_{ₗ}_{,m′]}^{p}^{ᵢ}|:pₗ≠pᵢ };
transmitting
$${X}_{{p}_{i} , {m}^{′}} = \begin{matrix}⊕ \\ {p}_{l} \neq {p}_{i}\end{matrix} {W}_{[ {p}_{l} , {m}^{′} ]}^{{p}_{i}}$$
by the node pᵢ, wherein ⊕ represents an exclusive or (XOR) operation; and
decoding a requirement W_{[p}_{ⱼ}_{,m′]}^{p}^{ᵢ} of a node pⱼ based on the Xₚ_{ᵢ}_{,m′}and a storage content of the node pⱼ after completing the transmitting, wherein a process for the decoding is expressed as follows:
$${X}_{{p}_{i} , {m}^{′}} ⊕ ( {⊕}_{{p}_{l} \neq {p}_{j} , {p}_{i}} {W}_{[ {p}_{l} , {m}^{′} ]}^{{p}_{i}} ) = ( {⊕}_{{p}_{l} \neq {p}_{i}} {W}_{[ {p}_{l} , {m}^{′} ]}^{{p}_{i}} ) ⊕ ( {⊕}_{{p}_{l} \neq {p}_{j} , {p}_{i}} {W}_{[ {p}_{l} , {m}^{′} ]}^{{p}_{i}} ) = {W}_{[ {p}_{j} , {m}^{′} ]}^{{p}_{i}} ;$$
$$wherein {⊕}_{{p}_{l} \neq {p}_{j} , {p}_{i}} {W}_{[ {p}_{l} , {m}^{′} ]}^{{p}_{i}}$$
represents an XOR transmission of a data packet W_{[p}_{ⱼ}_{,m′]}^{p}^{ᵢ} of another node pₗ after deleting the node pⱼ and the node pᵢ; and
$${X}_{{p}_{i} , {m}^{′}} ⊕ ( {⊕}_{{p}_{l} \neq {p}_{j} , {p}_{i}} {W}_{[ {p}_{l} , {m}^{′} ]}^{{p}_{i}} )$$
represents an XOR operation between an operation result of
$${⊕}_{{p}_{l} \neq {p}_{j} , {p}_{i}} {W}_{[ {p}_{l} , {m}^{′} ]}^{{p}_{i}}$$
and Xₚ_{ᵢ}_{,m′}^{p}^{ᵢ}
transmitted from the node pᵢ.

3. A rebalance method for blockchain-based decentralized file system, comprising an encoded data rebalance method of an added node, wherein the encoded data rebalance method of the added node comprises:
broadcasting, based on a preset decoding function, a codeword by each initial node to a target node when the target node is added into a node set; and
decoding the codeword by the target node using the preset decoding function, and deleting a corresponding data packet from each initial node, to thereby generate a distributed target file storage system.

4. The rebalance method for blockchain-based decentralized file system as claimed in claim 3, wherein the encoded data rebalance method of the added node comprises:
adopting [symbol] _{[K]} to represent an index of a bit set storing at K initial nodes, and
$${𝒜}_{[ K ]} = ( \begin{matrix}[ K ] \\ K - r\end{matrix} ) , wherein ( \begin{matrix}[ K ] \\ K - r\end{matrix} )$$
represents a set of subsets of K−r−1 nodes selected from a node set [K], [K] represents the node set, and r represents a replicator;
setting a node m∈ [symbol] _{[K]}, Uₘ={W_{[k,m]}:∀k∈[K]\m}; for a bit of a data packet W_{[k,m]}, using a node indexed by [K]\m to represent a node set initially storing the node, and [K]\m to represent remaining nodes in the node set [K] after deleting the node m; setting an initial node k∈[K], wherein the node m is different from the node k, and the data packet W_{[k,m]} is labeled and existed in storage of the node m; and
transmitting, by the initial node k∈[K], a data packet
$${W}_{[ k , m ]} : ∀ m ∈ ( \begin{matrix}[ K ] ∖ k \\ K - r\end{matrix} )$$
to a target node K+1, and deleting the data packet
$${W}_{[ k , m ]} : ∀ m ∈ ( \begin{matrix}[ K ] ∖ k \\ K - r\end{matrix} )$$
from the initial node, to thereby make the target node K+1 store the data packet transmitted by each initial node.
